(19) United States
(12) Patent Application Publication
(10) Pub. No.: US 2024/0286916 A1
(43) Pub. Date: Aug. 29, 2024

(54) METHOD FOR INTEGRATED UTILIZATION OF CALCIUM CHLORIDE SOLUTION AND CARBON DIOXIDE

(71) Applicant: East China University of Science and Technology, Shanghai (CN)

(72) Inventors: Chenglin LIU, Shanghai (CN); Jianguo YU, Shanghai (CN); Ying YANG, Shanghai (CN); Yuan MA, Shanghai (CN)

(73) Assignee: East China University of Science and Technology, Shanghai (CN)

(21) Appl. No.: 18/438,051

(22) Filed: Feb. 9, 2024

(30) Foreign Application Priority Data
Feb. 16, 2023 (CN) 202310120289.X
Jan. 16, 2024 (CN) 202410062063.3

(51) Int. Cl. C01F 11/18; C02F 1/469; C02F 103/34

(52) U.S. Cl. CPC C01F 11/181; C02F 1/4693; C01P 2004/61; C02F 2103/34; C02F 2201/46115

(57) ABSTRACT

The present invention provides a method for integrated utilization of a calcium chloride solution and CO₂. In this method, with the calcium chloride solution and the CO₂ being taken as raw materials, a water-soluble amine is added as an auxiliary agent to promote the occurrence of a mineralization reaction. As a result of crystallization following the reaction, calcium carbonate and a solution of a hydrochloride of the water-soluble amine are obtained. After the reaction is completed, the water-soluble amine is regenerated by subjecting a liquid phase resulting from separation to bipolar membrane electrodialysis, and dilute hydrochloric acid is obtained as a by-product at the same time. The method provides a novel perspective and approach to integrated utilization of calcium chloride-containing liquid waste and flue gas CO₂. The water-soluble amine allows excellent mineralization, and the bipolar membrane electrodialysis enables excellent regeneration of the amine. By means of process regulation, a calcium carbonate product of high value with controlled morphology and particle size can be obtained. For applications equipped with a lime kiln and allowing recycling of calcium carbonate, such as the ammonia-soda industry, the present invention also provides a combined cycle process for carbon and calcium resources, in which calcium carbonate produced by a mineralization reaction is calcined in lieu of limestone used in the soda production process to provide the soda production process with CO₂ and milk of lime, enabling recycling of carbon and calcium resources in an ammonia soda plant. The entire process is free of waste discharge, showing a promising prospect of application. It is of great significance to the fields of calcium chloride-containing liquid waste disposal and carbon emission reduction.

### TECHNICAL FIELD

The present invention pertains to the field of utilization of industrial waste as resources, and particularly relates to a method for integrated utilization of calcium chloride-containing liquid waste and flue gas CO₂ for producing a calcium carbonate product and dilute hydrochloric acid.

### BACKGROUND

Massive calcium chloride-containing liquid waste is discharged from industries, such as those involving soda ash production using the ammonia-soda process, dicalcium phosphate production through extraction with hydrochloric acid from ground phosphate rock, potassium chlorate production and polycrystalline silicon production, typically at a mass percentage ranging from 3% to 10%. At present, apart from some of these manufacturers who choose to produce solid calcium chloride by subjecting such waste to concentration and evaporation, most of them choose the traditional disposal method that involves direct discharge into a river, lake or sea after it becomes clear as a result of storage. This is tremendously detrimental to the environment and is a huge waste of resources. To date, there is still not a method capable of desirable disposal of calcium chloride-containing liquid waste, and such disposal is a common challenge to the aforesaid industries.

CN112850770A discloses a method of utilizing liquid waste from the ammonia-soda process as resources for use in brine extraction from a well dug in a sodium sulfate-rich salt mine. After the liquid waste from the ammonia-soda process is filled in place of freshwater into the well in the sodium sulfate-rich salt mine, calcium chloride contained in the liquid waste reacts with sodium sulfate in a cavity resulting from dissolution to form calcium sulfate dihydrate, which precipitates, and sodium chloride brine. The calcium sulfate fills the downhole cavity, and the brine is extracted for use. However, the calcium sulfate that precipitates at the bottom of the cavity will cover the underlying salt deposits and affect their mining. Moreover, sodium sulfate in the cavity will be gradually depleted as the liquid waste is more and more filled in the well, making the method unsustainable. Further, due to technical limitations, salt/gypsum, a by-product of this process, cannot be extracted from the well and produced into a useful product, leading to a tremendous waste of resources.

Moreover, the world's climate is changing dramatically and it has become an urgent task for us to reduce our CO₂ emissions. 43% of CO₂ emitted from human activities is contributed by coal-fired power plants which generate electricity as a supply of energy. Most chemical industrial parks are equipped with a power plant. CO₂ emissions from such power plants are often directly discharged after being desulfurized and denitrified, exacerbating the greenhouse effect. If calcium chloride-containing liquid waste from factories and flue gas CO₂ from power plants can be utilized in an integrated manner to produce more valuable products, multiple benefits can be gained in terms of economy, environment, society and the like because not only integrated utilization of the two types of waste can be achieved, but products of high added value can be obtained.

At present, some scholars have reported their research on integrated utilization of calcium chloride-containing liquid waste and CO₂. CN113104876A discloses a method using an oil-soluble amine as an extraction agent, which utilizes a reaction-extraction-crystallization process to convert calcium chloride and CO₂ into calcium carbonate and a hydrochloride of the oil-soluble amine. The calcium carbonate in the aqueous phase is obtained as a product through filtration. The oil-soluble amine is subsequently regenerated from the hydrochloride of the oil-soluble amine in the oil phase through thermal desorption for recycling. Moreover, HCl gas can be obtained from this method as a by-product. However, as the oil-soluble amine used in this method is highly viscous, the mineralization and thermal desorption steps each require the addition of a large amount of a diluent. This necessitates the subsequent separation of the diluent, which is an energy-consumptive and challenging task. Further, in the thermal desorption step, N₂ is introduced to carry the generated HCl gas away as soon as possible. Consequently, there is N₂ in the subsequently obtained HCl gas, which is difficult to separate, making it impossible to obtain high-purity HCl gas of high value.

Therefore, it would be of great significance to the disposal of calcium chloride-containing liquid waste and carbon emission reduction to develop a more feasible method for integrated disposal of calcium chloride-containing liquid waste and flue gas CO₂.

### SUMMARY

It is an object of the present invention to overcome the disadvantages of the prior art by presenting a method for integrated utilization of calcium chloride-containing liquid waste and flue gas CO₂, which allows utilization of the calcium chloride-containing liquid waste as resources and CO₂ emission reduction. A water-soluble amine is used as an auxiliary agent to promote the occurrence of a mineralization reaction, which produces a calcium carbonate product and a hydrochloride of the water-soluble amine. After that, in order to further produce a chlorine-containing product that can be used as resources, without giving rise to chlorine-containing liquid waste, the water-soluble amine is regenerated from its hydrochloride through bipolar membrane electrodialysis, and dilute hydrochloric acid is produced at the same time as a by-product. The water-soluble amine is circulated back to the mineralization section, enabling its recycling. The dilute hydrochloric acid can be used in another workshop of the factory. Compared with conventional oil-soluble amine based processes, this process is simpler, less energy-consumptive and significantly advantageous.

In applications equipped with a lime kiln, such as the ammonia-soda industry, CaCO₃ from mineralization of calcium chloride and CO₂ can be calcined in the lime kiln in place of externally purchased limestone. Accordingly, the present invention further provides a combined cycle process for carbon and calcium resources, in which the calcium carbonate produced by the mineralization reaction is calcined in lieu of limestone used in a soda production process to provide the soda production process with CO₂ and milk of lime, enabling recycling of carbon and calcium resources in an ammonia soda plant. As estimated, CO₂ emissions from thermal power plants of ammonia soda plants can accommodate the entire demand of soda ash production. Moreover, in addition to the demand of soda ash production, CO₂ emissions from lime kilns and carbonation towers can address the entire demand of mineralization of calcium chloride-containing liquid waste into calcium carbonate. Recycling of carbon and calcium resources dispenses with the need of the ammonia-soda industry for external purchase of limestone. Meanwhile, since calcium carbonate absent of Fe and various other impurities that may be present in limestone ores can be produced, improved calcination can be achieved compared with the use of limestone, with reduced accretion buildup in a lime kiln or the like.

Further, for other applications in which CaCl₂)-containing liquid waste can be utilized, the present invention also provides a method of producing calcium carbonate of high value with a controlled crystal form and particle size. Through regulation of various process parameters, this system can produce calcium carbonate of high value with controlled morphology and particle size.

In order to achieve the above objects, the present invention lies in:
a method for integrated utilization of a calcium chloride solution and CO₂, which comprises:
(1) mineralization, involving taking the calcium chloride solution and the CO₂ as raw materials, adding a water-soluble amine as an auxiliary agent to cause a mineralization reaction, which produces calcium carbonate and a hydrochloride of the water-soluble amine, and obtaining a calcium carbonate product from solid-liquid separation;
(2) regeneration, involving regenerating the water-soluble amine by subjecting a liquid phase from the separation to bipolar membrane electrodialysis and producing dilute hydrochloric acid as a by-product. The water-soluble amine can be circulated back to the mineralization reaction process in step (1) for reuse, and the dilute hydrochloric acid can be used in another production workshop in the plant.

The present invention may be further configured so that the calcium chloride solution is calcium chloride-containing industrial liquid waste from soda ash production based on the ammonia-soda process, or from production of dicalcium phosphate and potassium chlorate through extraction with hydrochloric acid from ground phosphate rock, or from polycrystalline silicon production or another industry. After undergoing pre-treatment for removal of impurities, the calcium chloride-containing liquid waste may be subjected to a mineralization reaction with the CO₂, and the calcium carbonate may be obtained from crystallization. Alternatively, the calcium carbonate may be directly obtained from mineralization of the calcium chloride-containing liquid waste with CO₂. Calcium chloride may be present at a concentration of 0.1-3 mol/L, preferably 0.5-3 mol/L in the calcium chloride solution.

The present invention may be further configured so that the CO₂ is flue gas CO₂ from one or more of flue gas from a thermal power plant, gas from a lime kiln and tail gas from a carbonation tower. The CO₂ may be present at a concentration of 2%-100%, preferably 2%-45% in the flue gas CO₂.

The present invention may be further configured so that, after being subjected to desulfurization and denitrification, the flue gas CO₂ is compressed or not, and then introduced into a reaction solution system. The CO₂ may be compressed to a pressure of up to 0.8 MPa.

The present invention may be further configured so that, the CO₂ is selectively added in such a manner that it is introduced into a solution of the water-soluble amine and then mixed with the calcium chloride-containing liquid waste to cause the mineralization reaction, or that it is introduced into the calcium chloride-containing liquid waste and then mixed with a solution of the water-soluble amine to cause the mineralization reaction, or that it is introduced into a mixed solution of a solution of the water-soluble amine and the calcium chloride-containing liquid waste to cause the mineralization reaction. In the former two addition approaches, absorption of the CO₂ is followed by the mineralization reaction. In the last addition approach, absorption of the CO₂ occurs at the same time as the mineralization reaction.

The present invention may be further configured so that the calcium chloride solution is mixed with the solution of the water-soluble amine by direct pouring or dropwise addition. The dropwise addition may occur at a rate of at least 0.0001 ml/min.

The present invention may be further configured so that a volume ratio of the calcium chloride solution to the solution of the water-soluble amine is 1:(0.5-3), that the mineralization reaction occurs at a temperature of 10-80° C., and that a molar ratio of calcium chloride to the water-soluble amine is 1:(0.4-10), preferably 1: (1-4).

The present invention may be further configured so that the water-soluble amine is selected from one or more of alkanolamine compounds, amino acid salt compounds, basic amino acid compounds, diamine compounds, polyamine compounds, aliphatic amine compounds, aromatic amine compounds, heterocyclic amine compound and biogenic amine compounds, among others.

In particular, the water-soluble amine may be selected from one or more of monoethanolamine (MEA), diethanolamine (DEA), triethanolamine (TEA), N-methyl diethanolamine (MDEA), 2-amino-2-methyl-1-propanol (AMP), sodium glycinate (GlyNa), arginine (Arg), piperazine (PZ), ethylenediamine (EDA), tetramethylethylenediamine (TEMED), triethylenetetramine (TETA), pyridine (PD), cadaverine, putrescine, spermine, spermidine, among others.

The present invention may be further configured so that the calcium carbonate product is obtained from filtration after the mineralization reaction is completed. The water-soluble amine may be regenerated for recycling by subjecting a solution of the hydrochloride of the water-soluble amine in a liquid phase to bipolar membrane electrodialysis, and dilute hydrochloric acid may be produced as a by-product at the same time.

Further, the bipolar membrane electrodialysis may be performed with a device of a salt-acid-base three-chamber structure with a membrane stack composed of alternating bipolar, cation exchange and anion exchange membranes, or of a salt-acid two-chamber structure with a membrane stack composed of alternating bipolar and anion exchange membranes.

In case of the bipolar membrane electrodialysis being conducted with the salt-acid-base three-chamber structure, as a result of a DC current being applied through the membrane stack, H₂O is split into H⁺ and OH⁻ at an intermediate catalyst layer of the bipolar membrane. H⁺ migrates towards the cathode through the cation exchange membrane and enters the acid chamber, and Cl⁻ in the salt chamber also enters the acid chamber through the anion exchange membrane, giving rise to HCl in the acid chamber. OH⁻ migrates towards the anode through the anion exchange membrane and enters the base chamber, and the protonated amine in the salt chamber also enters the base chamber through the cation exchange membrane, resulting in regeneration of the water-soluble amine in the base chamber.

In case of the bipolar membrane electrodialysis being conducted with the salt-acid two-chamber structure, as a result of a DC current being applied through the membrane stack, H₂O is split into H⁺ and OH⁻ at an intermediate catalyst layer of the bipolar membrane. OH⁻ is formed on the side of the salt chamber, and the H is formed on the side of the acid chamber. Cl⁻ in the salt chamber enters the acid chamber through the anion exchange membrane and combines with H⁺ in the acid chamber to form HCl. OH⁻ combines with the protonated amine retained in the salt chamber, regenerating the water-soluble amine in the salt chamber.

With this bipolar membrane electrodialysis technique, dilute hydrochloric acid and a solution of the regenerated water-soluble amine can be simultaneously obtained in the acid and base (or salt) chambers, respectively.

The present invention may be further configured so that, at the beginning operation of the bipolar membrane electrodialysis device, there are a 0.01-2.00 mol/L HCl solution in the acid chamber, a 0.01-2.00 mol/L NaOH solution in the base chamber, a solution of the hydrochloride of the water-soluble amine obtained as a liquid phase from the solid-liquid separation in the salt chamber and a 0.01%-10% Na₂SO₄ solution in an electrode solution chamber. In each chamber of the bipolar membrane electrodialysis device, there may be a flow rate preferred to be 10-200 L/h. A constant current preferably with a strength of 0.1-5.0 A may be applied.

The present invention also provides a carbon-calcium cycle process for industries equipped with a lime kiln, such as the soda production industry based on the ammonia-soda process. In the process, calcium chloride-containing liquid waste is obtained as liquid waste discharged from ammonia evaporation during soda ash production based on the ammonia-soda process, and calcium carbonate produced by a mineralization reaction is calcined in place of limestone used in a soda production process to provide the soda production process with CO₂ and milk of lime, allowing recycling of calcium resources and CO₂.

In particular, a calcium cycle in the carbon-calcium cycle process may involve: obtaining quicklime from calcination of limestone in the soda production process; obtaining milk of lime from slaking of the quicklime; obtaining liquid waste from evaporation of ammonia from the milk of lime; obtaining micro- or nano-sized calcium carbonate from mineralization of the liquid waste from the ammonia evaporation and CO₂; calcination of the calcium carbonate in place of limestone. This process is repeated to enable cycling of calcium in the soda production industry based on the ammonia-soda process.

A carbon cycle in the carbon-calcium cycle process may involve: providing flue gas CO₂ for the entire ammonia-soda process by a thermal power plant, a lime kiln or a carbonation tower; obtaining calcium carbonate from mineralization of the flue gas CO₂ and liquid waste from ammonia evaporation; providing hydrated lime and CO₂ for soda production by calcination of the calcium carbonate; and finally obtaining a sodium carbonate product and calcium carbonate. The sodium carbonate product can be sold, and the calcium carbonate is used to replace limestone and enable recycling.

The present invention may be further configured so that the carbon cycle further involves: concentrating the flue gas CO₂ after it is desulfurized and denitrified; and then using it to directly carbonate ammoniated brine in the soda production process to produce soda ash, and/or to treat liquid waste from the ammonia-soda process that has not been treated yet to produce a calcium carbonate product through mineralization. In this way, the flue gas CO₂ can be fully utilized, promoting carbon emission reduction in an ammonia soda plant.

The present invention also provides a mineralization process for producing a calcium carbonate product with controlled morphology, which can be used as a product of high value.

According to the present invention, each of the aforementioned various water-soluble amines may be used as an auxiliary agent to enable a calcium carbonate product to be obtained from a mineralization reaction. Meanwhile, due to differences of these water-soluble amines in group structure, calcium carbonate obtained as a result of using each of them as an auxiliary agent exhibits significantly different morphology and particle size. Through regulating the type of amine used and various process conditions, a micro- or nano-sized calcium carbonate product of high added value with controlled morphology and particle size can be obtained in the system. The selection of a particular water-soluble amine as an auxiliary agent, as well as process regulation specific therefor, is of particular importance. A calcium carbonate product is often in one of the three crystal forms: aragonite, vaterite and calcite. Calcium carbonate in the form of vaterite often exists as agglomerated spherical crystals. Calcium carbonate in the form of calcite often exists as regular rhombohedral crystals. Calcium carbonate in the form of aragonite tends to exist as needle-shaped crystals. Calcium carbonate products in different crystal forms are suitable for different applications. Improper process regulation may lead to the formation of a calcium carbonate product in a multi-crystalline form with heterogeneous morphology, which cannot be utilized as calcium carbonate of high value. In order to obtain a calcium carbonate product of high added value with controlled morphology and particle size, further regulation of the mineralization reaction process is necessary.

When the water-soluble amine is selected from diamine compounds, i.e., from one or more of piperazine (PZ), ethylenediamine (EDA), tetramethylethylenediamine (TEMED) and the like, the calcium carbonate product obtained in step (1) is calcium carbonate in the form of calcite with controlled morphology.

When the water-soluble amine is selected from amino acid salt compounds and basic amino acid compounds, i.e., from one or more of sodium glycinate (GlyNa), arginine (Arg) and the like, the calcium carbonate product obtained in step (1) is calcium carbonate in the form of vaterite with controlled morphology.

When the water-soluble amine is selected from alkanolamine compounds, i.e., from one or more of monoethanolamine (MEA), diethanolamine (DEA), triethanolamine (TEA), N-methyl diethanolamine (MDEA), 2-amino-2-methyl-1-propanol (AMP) and the like, the mineralization process may be further regulated as follows:

When the molar ratio of the calcium chloride to the water-soluble amine in the mineralization reaction is greater than 1:2, i.e., when the calcium chloride is added in excess, the calcium carbonate product obtained in step (1) is calcium carbonate in the form of calcite with controlled morphology. The molar ratio of the calcium chloride to the water-soluble amine is preferred to be 1:(0.4-2) or 1: (1-2), with 1:2 not being included in each case.

In the mineralization reaction, when the materials are added so that the solution of the water-soluble amine is added to the calcium chloride solution, further regulation can be effected through the following CO₂ addition modes:

When absorption of the CO₂ occurs simultaneously with the mineralization reaction, i.e., when the CO₂ is introduced into a mixed solution of the solution of the water-soluble amine and the calcium chloride solution to cause the mineralization reaction, the calcium carbonate product obtained in step (1) is calcium carbonate in a multi-crystalline form with heterogeneous morphology.

When absorption of the CO₂ is followed by the mineralization reaction, i.e., when the CO₂ is introduced into the solution of the water-soluble amine and then mixed with the calcium chloride-containing liquid waste, or when the CO₂ is introduced into the calcium chloride-containing liquid waste and then mixed with the solution of the water-soluble amine, the calcium carbonate product obtained in step (1) is calcium carbonate in the form of calcite with controlled morphology.

When the molar ratio of the calcium chloride to the water-soluble amine in the mineralization reaction is not greater than 1:2, and when the materials are added in such a manner that the calcium chloride solution is added to the solution of the water-soluble amine, further regulation can be effected through the following CO₂ addition modes and a temperature of the mineralization reaction:

When absorption of the CO₂ occurs simultaneously with the mineralization reaction, i.e., when the CO₂ is introduced into a mixed solution of the solution of the water-soluble amine and the calcium chloride solution to cause the mineralization reaction, the calcium carbonate product obtained in step (1) is calcium carbonate in a multi-crystalline form with heterogeneous morphology.

When absorption of the CO₂ is followed by the mineralization reaction, i.e., when the CO₂ is introduced into the solution of the water-soluble amine and then mixed with the calcium chloride-containing liquid waste, or when the CO₂ is introduced into the calcium chloride-containing liquid waste and then mixed with the solution of the water-soluble amine, the calcium carbonate product obtained will be calcium carbonate in the form of vaterite with controlled morphology if the mineralization reaction occurs at a low temperature, which is preferably 10-40° C., more preferably 20-30° C., or the calcium carbonate product obtained will be calcium carbonate in the form of calcite with controlled morphology if the mineralization reaction occurs at a high temperature, which is preferably 50-80° C., more preferably 60-70° C.

For the particle size of the calcium carbonate product, how the calcium chloride solution and the solution of the water-soluble amine are mixed (i.e., either by direct pouring, or by dropwise addition) and the concentration of the raw material solution are extremely important: a lower dropwise addition rate, as well as a lower concentration of the raw material solution, will result in a greater particle size of the calcium carbonate; and a higher dropwise addition rate, as well as a higher concentration of the raw material solution, will result in a smaller particle size of the calcium carbonate.

When the calcium chloride solution and the solution of the water-soluble amine are mixed by direct pouring, the calcium carbonate product obtained in step (1) is calcium carbonate with a small particle size. In particular, its average particle size may be smaller than 20 μm, preferably smaller than 10 μm, more preferably 2-10 μm. When the calcium chloride solution and the solution of the water-soluble amine are mixed by dropwise addition, the calcium carbonate product obtained in step (1) is calcium carbonate with a large particle size. In particular, its average particle size may be greater than 10 μm, preferably greater than 20 μm, more preferably 20-30 μm.

Compared with the prior art, the present invention has the following benefits:
(1) It provides a method for integrated utilization of calcium chloride-containing liquid waste and flue gas CO₂, in which, in the presence of a water-soluble amine added as an auxiliary agent, a calcium carbonate product is obtained from a mineralization reaction at a mineralization rate of as high as 99% or higher. In order to achieve more full utilization of chlorine resources and regeneration of the water-soluble amine, bipolar membrane electrodialysis is used to regenerate the amine at a rate of as high as 90% or higher. The regenerated water-soluble amine is obtained in a salt or base chamber and can be recycled, and dilute hydrochloric acid is obtained in an acid chamber and can be used in another workshop of the factory. Compared with oil-soluble amine based conventional processes, this process is simpler, less energy-consumptive and more excellent in terms of mineralization and amine regeneration performance.
(2) The present invention provides a carbon-calcium cycle process for the soda production industry based on the ammonia-soda process, which enables a soda production process to overall produce an industrial soda ash product and dilute hydrochloric acid as a by-product from a NaCl solution and flue gas CO₂ as raw materials. Subjecting liquid waste from ammonia evaporation to mineralization and crystallization and circulating it back to a limestone calcination section of the soda production process avoids external purchase of limestone used in the ammonia-soda industry and discharge or backfilling of the calcium chloride-containing liquid waste and realizes recycling of calcium resources. At the same time, the flue gas can be utilized in an integrated manner to produce industrial soda ash and realize recycling of carbon resources. The entire process is free of solid or liquid waste discharge, achieving integrated all-atom utilization.
(3) According to the present invention, through process optimization and regulation, a micro- or nano-sized calcium carbonate product of high added value with controlled morphology and particle size can be obtained from a mineralization reaction. In this way, calcium chloride-containing liquid waste and flue gas CO₂ can be converted into a calcium carbonate product of high value and dilute hydrochloric acid, enabling integrated utilization of the two types of waste. In addition to the product of high added value, carbon emission reduction can be promoted. Further, the whole process is free of waste discharge, making it significantly advantageous over conventional processes.

### BRIEF DESCRIPTION OF THE DRAWINGS

FIG. 1 shows a flowchart of a process for integrated utilization of calcium chloride-containing liquid waste and flue gas CO₂ according to the present invention.

FIG. 2 shows a flowchart of a process for producing soda ash based on the ammonia-soda process.

FIG. 3 shows a flowchart of a coupled carbon-calcium cycle process for the soda production industry based on the ammonia-soda process.

FIG. 4 is a schematic illustration of a coupled carbon-calcium cycle process for the soda production industry based on the ammonia-soda process.

FIG. 5 shows an XRD pattern of a calcium carbonate product prepared according to Example 2-1.

FIG. 6 shows an SEM image of the calcium carbonate product prepared according to Example 2-1.

FIG. 7 shows an XRD pattern of a calcium carbonate product prepared according to Example 3-1.

FIG. 8 shows an SEM image of the calcium carbonate product prepared according to Example 3-1.

FIG. 9 shows an XRD pattern of a calcium carbonate product prepared according to Example 4-1.

FIG. 10 shows an SEM image of the calcium carbonate product prepared according to Example 4-1.

FIG. 11 shows an XRD pattern of a calcium carbonate product prepared according to Example 4-2.

FIG. 12 shows an SEM image of the calcium carbonate product prepared according to Example 4-2.

FIG. 13 shows an XRD pattern of a calcium carbonate product prepared according to Example 4-5.

FIG. 14 shows an SEM image of the calcium carbonate product prepared according to Example 4-5.

FIG. 15 shows mobility profiles of Cl⁻ in an acid chamber as a result of treating hydrochlorides of various water-soluble amines by bipolar membrane electrodialysis.

FIG. 16 shows residual rate profiles of Cl⁻ in a salt chamber as a result of treating hydrochlorides of various water-soluble amines by bipolar membrane electrodialysis.

FIG. 17 shows amine regeneration rate profiles in a salt chamber as a result of treating hydrochlorides of various water-soluble amines by bipolar membrane electrodialysis.

### DETAILED DESCRIPTION

The present invention will be clearly and fully described below with reference to the specific examples below. It would be appreciated that the examples described herein are only some, but not all, possible embodiments of the invention. It is intended that any and all other embodiments made by those of ordinary skill in the art in light of those disclosed herein without exerting any creative effort are embraced in the scope of the invention.

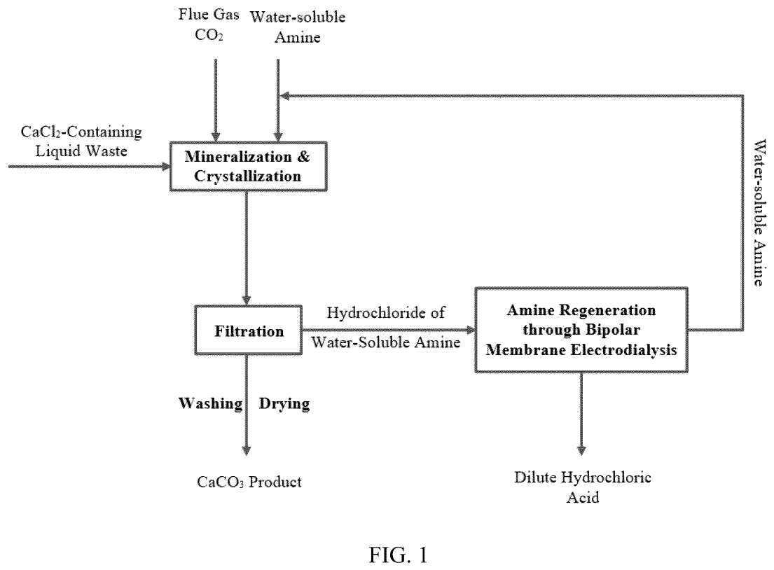

FIG. 1 shows a flowchart of a process for integrated utilization of calcium chloride-containing liquid waste and flue gas CO₂ according to the present invention. With the calcium chloride-containing liquid waste and flue gas CO₂ being used as raw materials, a water-soluble amine is added thereto as an auxiliary agent to promote a mineralization reaction. From filtration, solid calcium carbonate is obtained as a product, as well as a filtrate containing a hydrochloride of the water-soluble amine. In order to further recover the water-soluble amine and allow utilization of chlorine as resources without producing chlorine-containing liquid waste, the hydrochloride of the water-soluble amine is regenerated by bipolar membrane electrodialysis. As a result of the filtrate containing the hydrochloride of the water-soluble amine being added to a salt chamber, the regenerated water-soluble amine and dilute hydrochloric acid are simultaneously obtained in a salt chamber (or a base chamber) and an acid chamber, respectively. The regenerated water-soluble amine is circulated back to the mineralization section for reuse, and the dilute hydrochloric acid can be used in another workshop in the factory. The obtained calcium carbonate can be circulated to a limestone calcination section in a soda production line.

Alternatively, nano- or micro-sized calcium carbonate of high value with controlled morphology and particle size can be produced for sale, or for use in another workshop in the factory.

Reactions that occur respectively in the section for mineralization of CO₂ with the water-soluble amine and in the section for amine regeneration by bipolar membrane electrodialysis can be described by the following equations:

CaCl₂)+2RNH₂+CO₂+H₂O→CaCO₃↓+2RNH₂·HCl RNH₂·HCl→RNH₂+HCl

### Example 1: Carbon-Calcium Cycle Process in Soda Production Industry Based on Ammonia-Soda Process

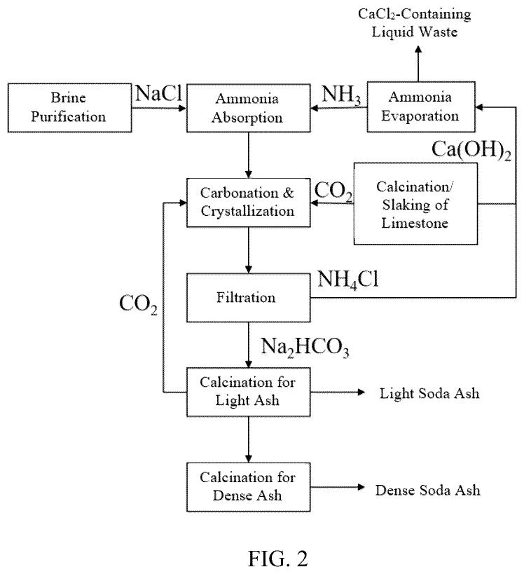

FIG. 2 shows a flowchart of a process for producing soda ash based on the ammonia-soda process, in which NH₃ is introduced and absorbed in a saturated solution of common salt to obtain ammoniated brine, and CO₂ is then further introduced to bring about a carbonation reaction. NaHCO₃ is then obtained by crystallization, and the obtained NaHCO₃ is filtered, separated and calcined, producing the soda ash product. CO₂ is recycled, and NH₃ is recovered by adding milk of lime to the filtrate that contains NH₄Cl and then performing an ammonia evaporation process thereon. CaCl₂)-containing liquid waste left from the ammonia evaporation process is directly discharged. The milk of lime is obtained from calcination and slaking of commercially available limestone, and CO₂ produced during the calcination is also recycled. Reactions in each section of the soda ash production line based on the ammonia-soda process can be described by the following equations:

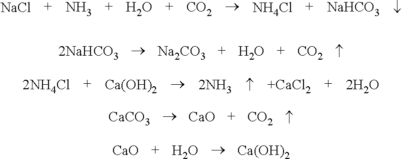

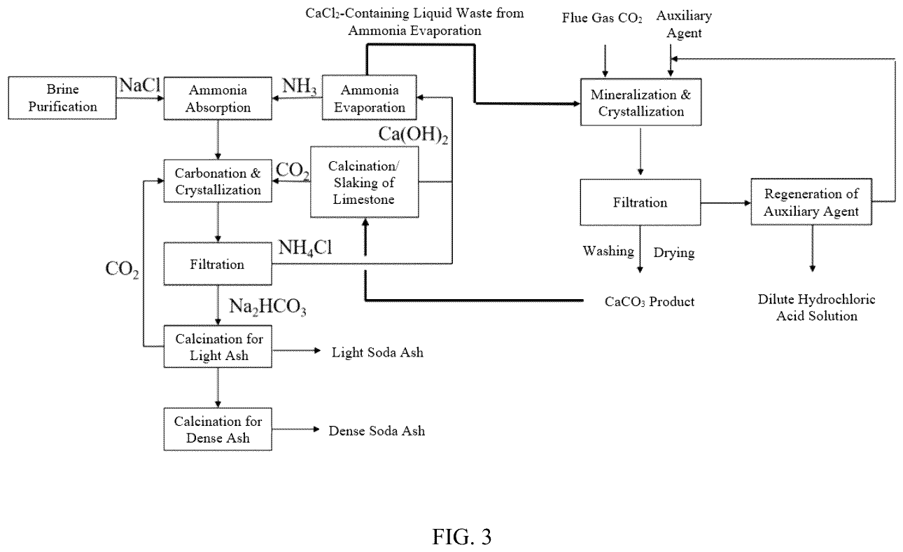

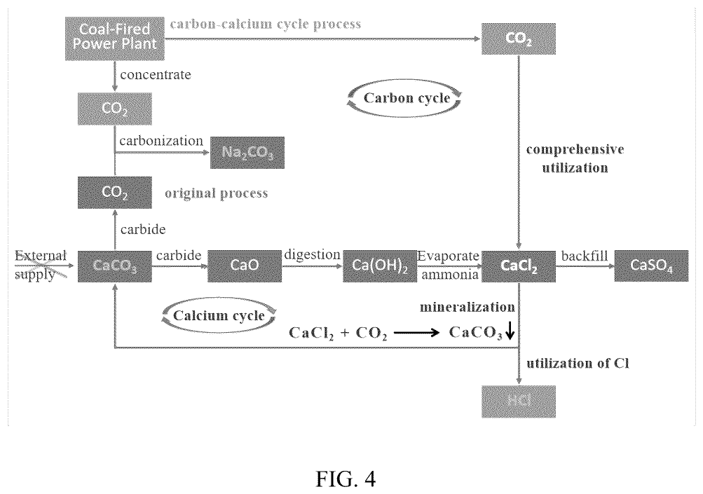

Combined reference is made to FIGS. 3 and 4, which are schematic flowcharts of a carbon-calcium cycle process for the ammonia-soda industry according to the present invention. This process enables integrated utilization of the calcium chloride-containing liquid waste resulting from the ammonia evaporation in the ammonia-soda industry and flue gas CO₂. Specifically, it includes the steps as follows:

Step I: liquid waste pre-treatment. The liquid waste from the ammonia evaporation in the soda production process based on the ammonia-soda process is pre-treated for removal of impurities therefrom, giving CaCl₂)-containing liquid waste. The removed impurities include insoluble solid residues and impurity ions other than calcium, sodium and chlorine ions. CaCl₂) is present at a concentration of 0.5-3 mol/L in the liquid waste from the ammonia evaporation.

Step II: flue gas CO₂ pre-treatment. After being desulfurized and denitrified, the flue gas CO₂ is compressed and then introduced into a solution of an auxiliary agent. Alternatively, the desulfurized and denitrified flue gas CO₂ may be directly introduced into the auxiliary agent without being compressed. The flue gas CO₂ may be compressed to a pressure of up to 0.8 MPa. The auxiliary agent is a water-soluble amine.

Step III: mineralization reaction. The CaCl₂)-containg liquid waste is introduced into the solution of the auxiliary agent, in which the flue gas CO₂ has been absorbed, causing a mineralization reaction. Micro- or nano-sized calcium carbonate is obtained from crystallization. The CaCl₂)-containg liquid waste is added at a volume ratio of 1:(0.5-3) to the solution of the auxiliary agent.

Step IV: As a result of solid-liquid separation being conducted after the mineralization reaction, calcium carbonate is obtained as a solid, as well as a solution of a hydrochloride of the auxiliary agent. After being washed and dried, the solid calcium carbonate is fed to a limestone calcination section in the soda ash production line based on the ammonia-soda process, where it is calcined in a lime kiln, producing CaO and CO₂, which are then used respectively for ammonia evaporation and carbonation of ammoniated brine for soda production after slaking in the soda ash production process based on the ammonia-soda process.

Step V: The solution of the hydrochloride of the auxiliary agent resulting from solid-liquid separation is fed to an auxiliary agent regeneration section, where the regenerated auxiliary agent is recycled and dilute hydrochloric acid is obtained as a by-product. The chlorine-containing product can be used as resources in another workshop in the ammonia soda plant or sold. The auxiliary agent is regenerated through bipolar membrane electrodialysis.

Step VI: The above steps are repeated on the liquid waste resulting from the ammonia evaporation conducted after the addition of milk of lime. This is coupled with flue gas CO₂ mineralization and crystallization, enabling carbon-calcium cycling in the ammonia-soda industry.

It is to be noted that the above-described carbon-calcium cycle process for the soda production industry based on the ammonia-soda process according to the present invention enables recycling of calcium resources and carbon resources. The numbering of steps I to VI above does not represent an absolute sequential ordering. That is, these steps are not limited to being performed one before or after another in time. For the coupled carbon-calcium cycle process for the soda production industry based on the ammonia-soda process, the mineralization reaction section, the auxiliary agent regeneration section and the carbon-calcium cycling for the mineralization reaction are important.

In the coupled carbon-calcium cycle process for the soda production industry based on the ammonia-soda process, soda production based on the ammonia-soda process can be described by the following overall equation:

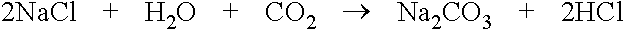

The ammonia-soda industry uses a NaCl solution and flue gas CO₂ as raw materials to produce industrial soda ash as a product and dilute hydrochloric acid as a by-product. Subjecting the liquid waste from the ammonia evaporation to mineralization and crystallization and circulating it back to the limestone calcination section of the ammonia-soda process avoids external purchase of limestone used in the ammonia-soda industry and discharge or backfilling of the calcium chloride-containing liquid waste and realizes recycling of calcium resources. At the same time, flue gas from a thermal power plant can be utilized in an integrated manner to produce industrial soda ash and realize recycling of carbon resources. The entire process is free of solid or liquid waste discharge, achieving integrated all-atom utilization.

### Example 2-4 Mineralization Processes for Producing Calcium Carbonate of High Value with Controlled Morphology and Particle Size

### Example 2

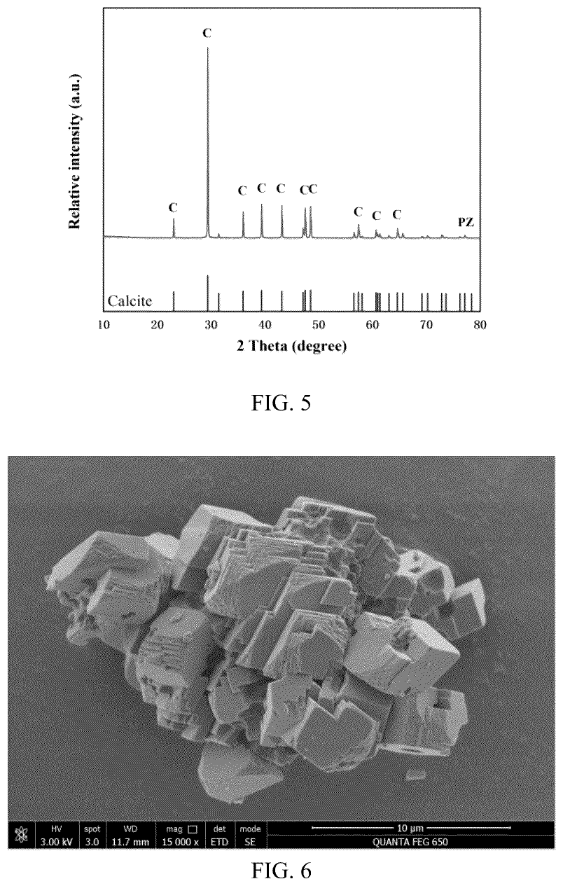

In a jacketed reactor, 100 ml of a 1 mol/L piperazine (PZ) solution was added. Stirring was conducted at a controlled speed of 200 r/min, with the reaction temperature being controlled at 25° C. In the reaction system, 15% CO₂ gas was introduced at a controlled input rate of 500 ml/min. After the reaction ran for 1 h, the solution of the water-soluble amine was saturated with CO₂, and the CO₂ supply was halted. 50 mL of liquid waste containing CaCl₂) at 1 mol/L was added dropwise into the jacketed reactor at a rate of 1.667 ml/min. The stirring speed was maintained at 200 r/min, and the reaction temperature was kept at 25° C. The reaction was stop after 0.5 h. Filtration was carried out, and the resulting filter cake was washed several times with deionized water and ethanol and then dried in an oven at 110° C., obtaining calcium carbonate as a product, denoted as Example 2-1. As calculated based on the results of an ICP test, 98.87% of calcium chloride was converted by the first-order reaction, and calcium carbonate was obtained at a yield of 95.59%. According to X-ray diffraction (XRD) and scanning electron microscopy (SEM) analysis, as shown in FIGS. 5 to 6, the calcium carbonate product was obtained as cubic calcite with an average particle size of 16.65 μm.

Examples 2-2 to 2-5 were each produced in a similar way except for differences in process conditions and reaction results as summarized in the table below. Examples 2-2 to 2-5 showed the same XRD and SEM results as Example 2-1. In the table, “A” stands for “absorption followed by mineralization”, a mode in which the CO₂ gas was first introduced into the solution of the water-soluble amine and then mixed with the CaCl₂)-containing liquid waste; “B” stands for “simultaneous absorption and mineralization”, a mode in which the solution of the water-soluble amine was mixed with the CaCl₂)-containing liquid waste and the CO₂ gas was then introduced; “c” (dropwise) stands for “dropwise addition of the CaCl₂)-containing liquid waste to the solution of the water-soluble amine; “d” (pouring) stands for “direct pouring of the CaCl₂)-containing liquid waste into the solution of the water-soluble amine”; and “e” (Calcium/Amine Ratio) stands for a molar ratio of calcium chloride to the water-soluble amine, which were raw materials for the reaction. The same denotations apply to the following description.

According to the results of Examples 2-1 to 2-5, when the water-soluble amine is selected from diamine compounds, calcium carbonate is obtained as a product of mineralization in the form of calcite with controlled morphology, without being limited by any other process conditions.

| | | | | Calcium/Amine | | | | Average |
|---|---|---|---|---|---|---|---|---|
| | Water-Soluble | Addition | Mixing of | Ratio ^{e} | Reaction | Mineralization | Crystal | Particle |
| Example | Amine | of CO₂ | Solution | (n:n) | Temperature | Percentage | Form | Size |
| 2-1 | piperazine | A | dropwise ^{c} | 1:2 | 25° C. | 95.59% | calcite | 16.65 μm |
| 2-2 | piperazine | A | pouring ^{d} | 1:1 | 40° C. | 80.34% | | 7.44 μm |
| 2-3 | piperazine | B | pouring | 1:2 | 70° C. | 96.47% | | 9.56 μm |
| 2-4 | ethylenediamine | A | dropwise | 1:4 | 25° C. | 94.26% | | 12.53 μm |
| 2-5 | Tetramethyleth- | A | dropwise | 1:2 | 40° C. | 92.43% | | 15.37 μm |
| | ylenediamine | | | | | | | |

### Example 3

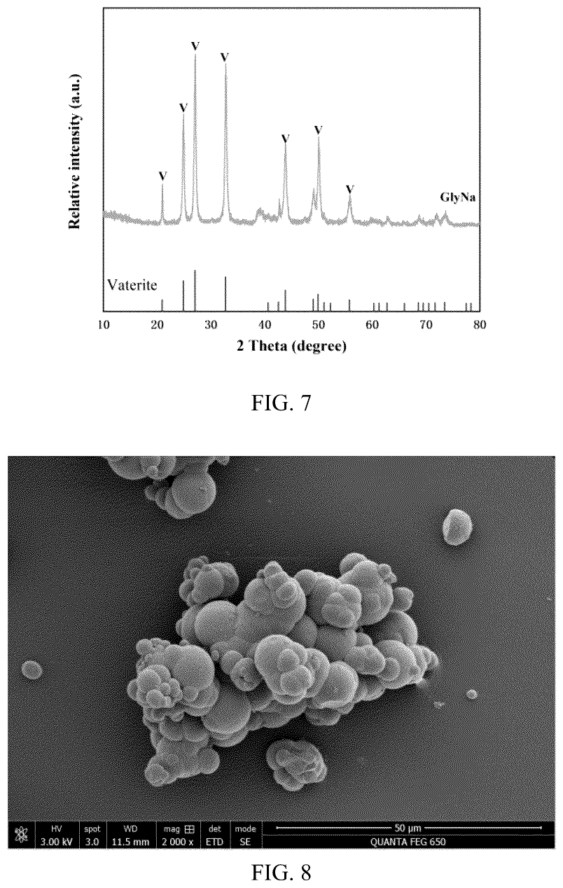

In a jacketed reactor, 100 ml of a 1 mol/L sodium glycinate (GlyNa) solution was added. Stirring was conducted at a controlled speed of 200 r/min, with the reaction temperature being controlled at 25° C. In the reaction system, 15% CO₂ gas was introduced at a controlled input rate of 500 ml/min. After the reaction ran for 1 h, the solution of the water-soluble amine was saturated with CO₂, and the CO₂ supply was halted. 50 mL of liquid waste containing CaCl₂) at 1 mol/L was added dropwise into the jacketed reactor at a 25 rate of 1.667 ml/min. The stirring speed was maintained at 200 r/min, and the reaction temperature was kept at 25° C. The reaction was terminated after 0.5 h. Filtration was carried out, and the resulting filter cake was washed several times with deionized water and ethanol and then dried in an oven at 110° C., obtaining calcium carbonate as a product, denoted as Example 3-1. As calculated based on the results of an ICP test, 98.30% of calcium chloride was converted by the first-order reaction, and calcium carbonate was obtained at a yield of 96.48%. According to XRD and SEM analysis, as shown in FIGS. 7 to 8, the calcium carbonate product was obtained as spherical vaterite with an average particle size of 34.6 μm.

Examples 3-2 to 3-5 were each produced in a similar way except for differences in process conditions and reaction results as summarized in the table below. Examples 3-2 to 3-5 showed the same XRD and SEM results as Example 3-1.

According to the results of Examples 3-1 to 3-5, when the water-soluble amine is selected from amino acid salt compounds and basic amino acid compounds, calcium carbonate is obtained as a product of mineralization in the form of vaterite with controlled morphology, without being limited by any other process conditions.

| | | | | Calcium/Amine | | | | Average |
|---|---|---|---|---|---|---|---|---|
| | Water-Soluble | Addition | Mixing of | Ratio | Reaction | Mineralization | Crystal | Particle |
| Example | Amine | of CO₂ | Solution | (n:n) | Temperature | Percentage | Form | Size |
| 3-1 | sodium | A | dropwise | 1:2 | 25° C. | 96.48% | vaterite | 34.6 μm |
| | glycinate | | | | | | | |
| 3-2 | sodium | A | pouring | 1:2 | 40° C. | 97.5% | | 12.8 μm |
| | glycinate | | | | | | | |
| 3-3 | sodium | B | pouring | 1:4 | 70° C. | 98.4% | | 7.5 μm |
| | glycinate | | | | | | | |
| 3-4 | arginine | A | dropwise | 1:2 | 40° C. | 97.7% | | 19.4 μm |
| 3-5 | arginine | A | dropwise | 1:1 | 25° C. | 90.2% | | 13.7 μm |

### Example 4

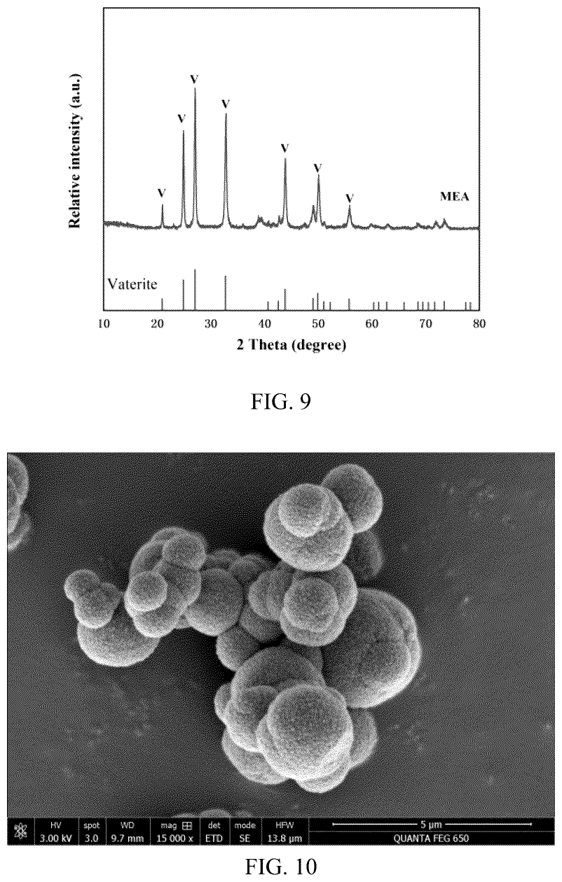

In a jacketed reactor, 100 ml of a 1 mol/L monoethanolamine (MEA) solution was added. Stirring was conducted at a controlled speed of 200 r/min, with the reaction temperature being controlled at 25° C. In the reaction system, 15% CO₂ gas was introduced at a controlled input rate of 500 ml/min. After the reaction ran for 1 h, the solution of the water-soluble amine was saturated with CO₂, and the CO₂ supply was halted. 50 mL of liquid waste containing CaCl₂) at 1 mol/L was added dropwise into the jacketed reactor at a rate of 1.667 ml/min. The stirring speed was maintained at 200 r/min, and the reaction temperature was kept at 25° C. The reaction was terminated after 0.5 h. Filtration was carried out, and the resulting filter cake was washed several times with deionized water and ethanol and then dried in an oven at 110° C., obtaining calcium carbonate as a product, denoted as Example 4-1. As calculated based on the results of an ICP test, 99.18% of calcium chloride was converted by the first-order reaction, and calcium carbonate was obtained at a yield of 97.52%. According to XRD and SEM analysis, as shown in FIGS. 9 to 10, the calcium carbonate product was obtained as spherical vaterite with an average particle size of 7.6 μm.

Examples 4-2 to 4-16 were each produced in a similar way using a water-soluble alkanolamine, except for differences in process conditions and reaction results as summarized in the table below.

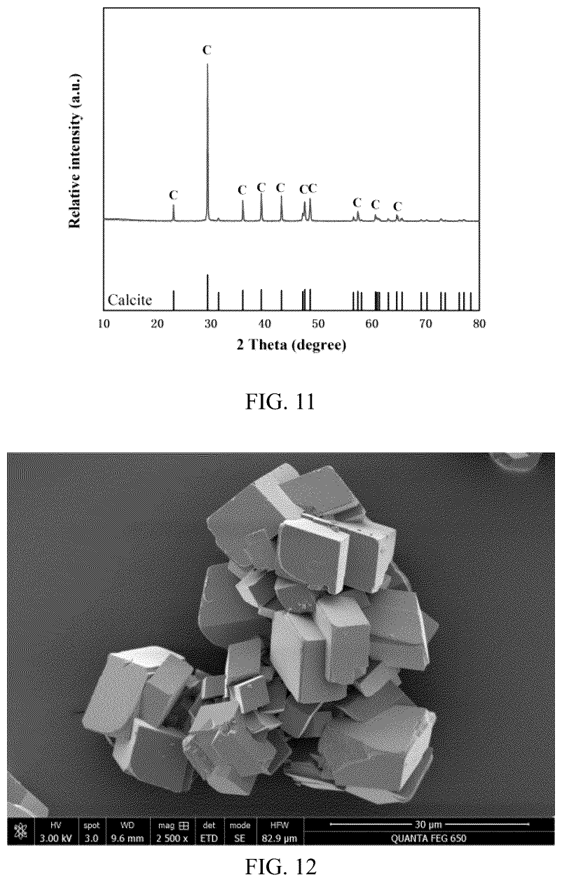

According the results of Examples 4-1 to 4-4, XRD and SEM analysis of the product prepared according to Example 4-2 is as shown in FIGS. 11 to 12, Examples 4-3 to 4-4 show the same XRD and SEM results as Example 4-2. When a molar ratio of calcium chloride to the water-soluble amine is greater than 1:2, i.e., when calcium chloride is added in excess, calcium carbonate will be obtained as a product in the form of calcite with controlled morphology.

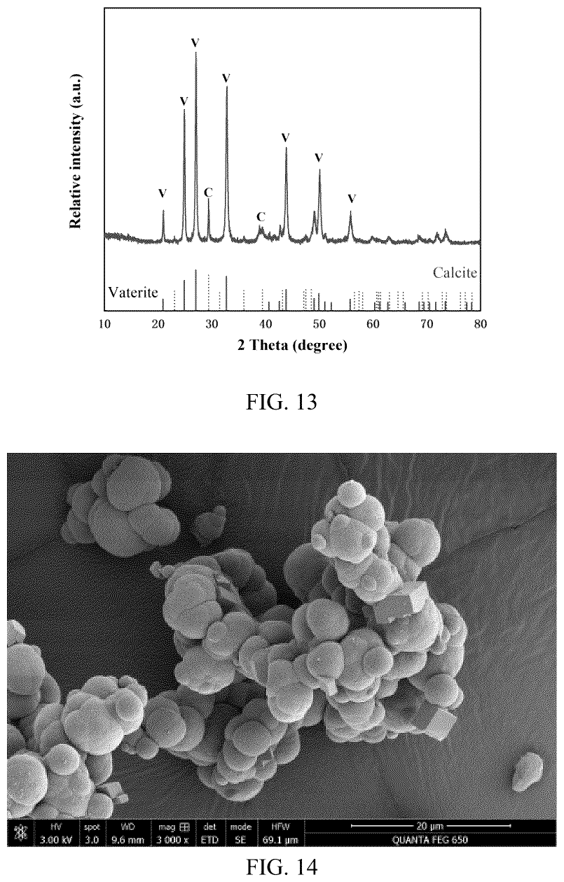

According the results of Examples 4-5 to 4-11, when the molar ratio of calcium chloride to the water-soluble amine is not greater than 1:2, i.e., when the water-soluble amine is added in stoichiometric equivalence or excess, if CO₂ absorption occurs simultaneously with the mineralization reaction, i.e., if the introduced CO₂ experiences the mineralization reaction in a mixed solution of the solution of the water-soluble amine and the calcium chloride solution, then calcium carbonate will be obtained as a product existing in a multi-crystalline form. For the results of Examples 4-5 to 4-6, reference can be made to FIGS. 13 to 14, which show XRD and SEM analysis of the product prepared according to Example 4-5.

When CO₂ is absorbed and then mineralized, i.e., when CO₂ is introduced into the solution of the water-soluble amine and then mixed with the calcium chloride-containing liquid waste, the calcium carbonate product will be obtained as vaterite with controlled morphology if the mineralization reaction is carried out at a low temperature, or as calcite with controlled morphology if the mineralization reaction is carried out at a high temperature. According to the results of Examples 4-7 to 4-11, the morphology of Examples 4-7 to 4-8 is similar to that of Example 4-1, and all the products were obtained in the form of vaterite. Moreover, the morphology of Examples 4-9 to 4-10 is similar to that of Example 4-2, and all the products were obtained in the form of calcite. Example 4-11 was obtained in a multi-crystalline form.

Examples 4-12 to 4-16 differ from Example 4-1 in that the solution of the water-soluble amine and the CaCl₂)-containing liquid waste were added in opposite orders. In the table, “a” also stands for “absorption followed by mineralization”, but this refers to a mode in which, after the CaCl₂)-containing liquid waste was added to the jacketed reactor, the CO₂ gas was introduced into the reaction system until saturation was reached, and the solution of the water-soluble amine was then added to the jacketed reactor to cause the mineralization reaction. Moreover, “b” also stands for “simultaneous absorption and mineralization”, but this refers to a mode in which, the solution of the water-soluble amine was added to and mixed with the CaCl₂)-containing liquid waste and the CO₂ gas was then introduced. All the other operation regulation parameters were the same as Example 4-1.

According to the results of Examples 4-12 to 4-16, when the materials are added in such an order that, during the addition of the solution of the water-soluble amine to the calcium chloride solution, CO₂ absorption is followed by a mineralization reaction, i.e., CO₂ is introduced into the calcium chloride-containing liquid waste and then mixed with the solution of the water-soluble amine, calcium carbonate will be obtained as a product in the form of calcite with controlled morphology, without being limited by any other process conditions. According to the results of Examples 4-12 to 4-14, the morphology of the products is similar to that of Example 4-2. When the materials are added in such an order that CO₂ absorption occurs at the same time as a mineralization reaction, i.e., CO₂ is introduced into a mixed solution of the solution of the water-soluble amine and the calcium chloride solution to cause a mineralization reaction, calcium carbonate will be obtained as a product with heterogeneous morphology in a multi-crystalline form. For this, reference can be made to the results of Examples 4-15 to 4-16.

| | | | | Calcium/Amine | | | | Average | |
|---|---|---|---|---|---|---|---|---|---|
| | Water-Soluble | Addition | Mixing of | Ratio | Reaction | Mineralization | Crystal | Particle | |
| Example | Amine | of CO₂ | Solution | (n:n) | Temperature | Percentage | Form | Size | |
| 4-1 | MEA | A | dropwise | 1:2 | 25° C. | 97.52% | vaterite | 12.6 | μm |
| 4-2 | MEA | A | dropwise | 1:1 | 25° C. | 83.66% | calcite | 10.3 | μm |
| 4-3 | AMP | A | dropwise | 1:0.5 | 65° C. | 70.52% | calcite | 11.2 | μm |
| 4-4 | MDEA | B | dropwise | 1:1 | 25° C. | 81.46% | calcite | 13.8 | μm |
| 4-5 | MEA | B | dropwise | 1:4 | 25° C. | 99.23% | multi-crystalline | 14.7 | μm |
| 4-6 | TEA | B | dropwise | 1:4 | 25° C. | 99.33% | multi-crystalline | 18.9 | μm |
| 4-7 | MEA | A | dropwise | 1:4 | 25° C. | 98.79% | vaterite | 20.8 | μm |
| 4-8 | TEA | A | pouring | 1:2 | 25° C. | 97.44% | vaterite | 7.9 | μm |
| 4-9 | TEA | A | pouring | 1:4 | 65° C. | 98.59% | calcite | 6.3 | μm |
| 4-10 | MEA | A | dropwise | 1:2 | 65° C. | 97.25% | calcite | 13.4 | μm |
| 4-11 | MEA | A | dropwise | 1:4 | 45° C. | 99.53% | multi-crystalline | 15.5 | μm |
| 4-12 | MEA | a | dropwise | 1:2 | 25° C. | 98.62% | calcite | 18.2 | μm |
| 4-13 | DEA | a | dropwise | 1:2 | 65° C. | 97.96% | calcite | 16.9 | μm |
| 4-14 | MDEA | a | pouring | 1:4 | 25° C. | 99.46% | calcite | 10.7 | μm |
| 4-15 | TEA | b | dropwise | 1:2 | 25° C. | 97.88% | multi-crystalline | 23.4 | μm |
| 4-16 | MEA | b | pouring | 1:2 | 25° C. | 97.69% | multi-crystalline s | 8.9 | μm |

### Example 5 Processes for Amine Regeneration Through Bipolar Membrane Electrodialysis

Filtrates resulting from filtration conducted in Examples 2-1, 3-1,4-1, 4-3,4-4, 4-8 (which were solutions of hydrochlorides of piperazine, sodium glycinate, monoethanolamine, 2-amino-2-methyl-1-propanol, N-methyl diethanolamine and triethanolamine) were treated by bipolar membrane electrodialysis for recovery of the water-soluble amines and preparation of dilute hydrochloric acid.

Each filtrate was treated by bipolar membrane electrodialysis, which was conducted with a salt-acid two-chamber structure, including: a salt chamber initially containing 300 ml of a solution of the filtrate; an acid chamber initially containing 300 ml of a 0.03 mol/L dilute hydrochloric acid solution; and an electrode solution chamber containing 300 ml of a 0.3 mol/L Na₂SO₄ solution. The treatment was carried out at a constant current of 0.5 A provided by a DC power supply and at a flow rate of 500 ml/min in each chamber. The regenerated water-soluble amine and dilute hydrochloric acid were obtained in the salt and acid chambers, respectively, 60-100 min after the treatment began.

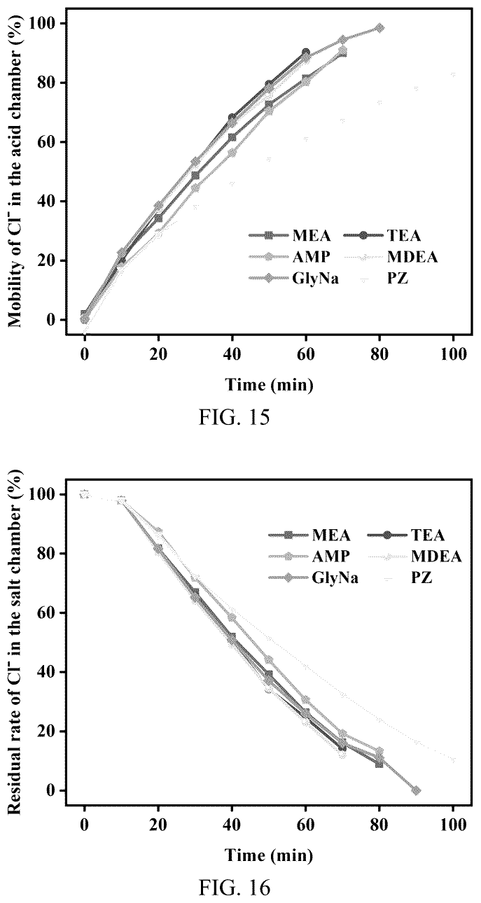

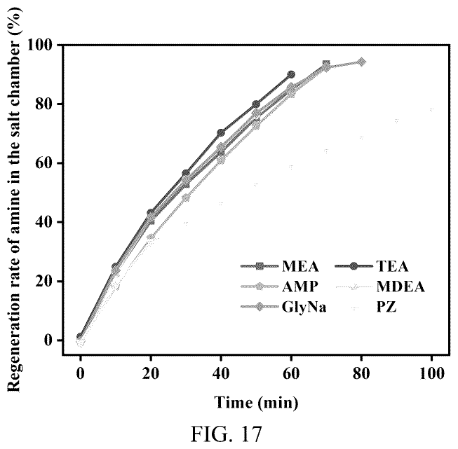

All the water-soluble amines can be regenerated from their hydrochlorides through bipolar membrane electrodialysis in an excellent manner. All the water-soluble amines, except for piperazine, can be regenerated at a rate of 90% or higher. FIG. 15 shows mobility of Cl⁻ in the acid chamber as a result of treating the hydrochlorides of the various water-soluble amines by bipolar membrane electrodialysis. FIG. 16 shows residual rates of Cl⁻ in the salt chamber as a result of treating the hydrochlorides of the various water-soluble amines by bipolar membrane electrodialysis. FIG. 17 shows amine regeneration rate in the salt chamber as a result of treating the hydrochlorides of the various water-soluble amines by bipolar membrane electrodialysis.

The above-discussed method for integrated utilization of calcium chloride-containing liquid waste and flue gas CO₂ through mineralization with a water-soluble amine and regeneration of the amine by bipolar membrane electrodialysis is applicable to solutions of various water-soluble amines. The mineralization process is easy to implement and can provide excellent mineralization performance, and the resulting calcium carbonate can be circulated to a carbon-calcium cycling like that in a soda production process based on the ammonia-soda process. In addition, the process can be regulated to produce micro- or nano-sized calcium carbonate of high value with controlled morphology and particle size for sale or use in another workshop in the factory. Various water-soluble amines can be regenerated by bipolar membrane electrodialysis from their hydrochlorides in filtrates from the process, and dilute hydrochloric acid can be obtained at the same time. Various water-soluble amines can be regenerated from their hydrochlorides in an excellent manner. This method enables integrated utilization of calcium chloride-containing liquid waste and flue gas CO₂ and can produce a calcium carbonate product of high value and dilute hydrochloric acid. It is significantly advantageous over conventional processes and provides a novel perspective and approach to calcium chloride disposal and carbon emission reduction. The process is highly feasible and shows a promising prospect of application.

The detailed description of the present application set forth herein is intended to enable those familiar with the art to understand the disclosure of the present application and to practice the application, and is not meant to limit the scope thereof in any sense. Any and all equivalent variations or modifications made within the substantive spirit of the application are all intended to be embraced within the scope thereof.

1. A method for integrated utilization of a calcium chloride solution and CO₂, characterized in comprising:
(1) taking the calcium chloride solution and the CO₂ as raw materials, adding a water-soluble amine as an auxiliary agent to cause a mineralization reaction, which produces calcium carbonate and a hydrochloride of the water-soluble amine, and obtaining a calcium carbonate product from solid-liquid separation;
(2) regenerating the water-soluble amine by subjecting a liquid phase from the separation to bipolar membrane electrodialysis and producing dilute hydrochloric acid as a by-product.

2. The method according to claim 1, characterized in that the calcium chloride solution is calcium chloride-containing liquid waste discharged from soda ash production based on the ammonia-soda process, or from production of dicalcium phosphate and potassium chlorate through extraction with hydrochloric acid from ground phosphate rock, or from polycrystalline silicon production and has a concentration of 0.1-3 mol/L, wherein
the CO₂ is from flue gas CO₂ emitted from a power plant, a lime kiln or a carbonation tower and is present in the flue gas CO₂ at a concentration of from 2% to 100%.

3. The method according to claim 1, characterized in that the mineralization reaction occurs at a temperature of 10-80° C., wherein:
a molar ratio of calcium chloride to the water-soluble amine is 1:(0.4-10), preferably 1: (1-4); and
the CO₂ is added in such a manner that it is introduced into a solution of the water-soluble amine and then mixed with the calcium chloride-containing liquid waste to cause the mineralization reaction, or that it is introduced into the calcium chloride-containing liquid waste and then mixed with a solution of the water-soluble amine to cause the mineralization reaction, or that it is introduced into a mixed solution of a solution of the water-soluble amine and the calcium chloride-containing liquid waste to cause the mineralization reaction.

4. The method according to claim 1, characterized in that the water-soluble amine is selected from one or more of alkanolamine compounds, amino acid salt compounds, basic amino acid compounds, diamine compounds, polyamine compounds, aliphatic amine compounds, aromatic amine compounds, heterocyclic amine compounds and biogenic amine compounds.

5. The method according to claim 4, characterized in that the water-soluble amine is selected from one or more of monoethanolamine (MEA), diethanolamine (DEA), triethanolamine (TEA), N-methyl diethanolamine (MDEA), 2-amino-2-methyl-1-propanol (AMP), sodium glycinate (GlyNa), arginine (Arg), piperazine (PZ), ethylenediamine (EDA), tetramethylethylenediamine (TEMED), triethylenetetramine (TETA), pyridine (PD), cadaverine, putrescine, spermine and spermidine.

6. The method according to claim 1, characterized in that the bipolar membrane electrodialysis is conducted with a device of a salt-acid-base three-chamber structure, or of a salt-acid two-chamber structure, wherein dilute hydrochloric acid is produced as a by-product in an acid chamber, and the water-soluble amine is regenerated in a base chamber or in a salt chamber in the form of a solution thereof, which is then circulated back to the mineralization process in step (1) for reuse.

7. The method according to claim 6, characterized in that, at the beginning of operation of the bipolar membrane electrodialysis device, there are a 0.01-2.00 mol/L HCl solution in the acid chamber, a 0.01-2.00 mol/L NaOH solution in the base chamber, a solution obtained as a liquid phase from the solid-liquid separation in the salt chamber, and a 0.01%-10% Na₂SO₄ solution in an electrode solution chamber, wherein there is a flow rate of 10-200 L/h in each chamber of the bipolar membrane electrodialysis device, and a constant current with a strength of 0.1-5.0 A is applied.

8. The method according to claim 2, characterized in that, the calcium chloride-containing liquid waste is liquid waste discharged from ammonia evaporation during soda ash production based on the ammonia-soda process, wherein the calcium carbonate produced by the mineralization reaction is calcined in place of limestone used in a soda production process based on the ammonia-soda process to provide the soda production process with CO₂ and milk of lime, allowing recycling of calcium resources and CO₂.

9. The method according to claim 8, characterized in that the flue gas CO₂ is concentrated after being subjected to desulfurization and denitrification and then used to directly carbonate ammoniated brine in the soda production process to produce soda ash, and/or to treat liquid waste from the ammonia-soda process that has not been treated yet to produce a calcium carbonate product through mineralization.

10. The method according to claim 2, characterized in that, after being subjected to desulfurization and denitrification, the flue gas CO₂ is compressed or not, and then introduced into a reaction solution system, wherein the flue gas CO₂ is compressed to a pressure of up to 0.8 MPa.

11. The method according to claim 4, characterized in that when the water-soluble amine is selected from diamine compounds, the calcium carbonate product obtained in step (1) is calcium carbonate in the form of calcite.

12. The method according to claim 4, characterized in that when the water-soluble amine is selected from amino acid salt compounds and basic amino acid compounds, the calcium carbonate product obtained in step (1) is calcium carbonate in the form of vaterite.

13. The method according to claim 4, characterized in that when the water-soluble amine is selected from alkanolamine compounds, regulation is performed through a mineralization process comprising:
when a molar ratio of the calcium chloride to the water-soluble amine is greater than 1:2, obtaining the calcium carbonate product in step (1) as calcium carbonate in the form of calcite, wherein the ratio of the two is preferred to be 1:(0.4-2), not including 1:2;
when the materials are added so that a solution of the water-soluble amine is added to the calcium chloride solution, and when the CO₂ is added in such a manner that it is introduced into the solution of the water-soluble amine and then mixed with calcium chloride-containing liquid waste, or that it is introduced into calcium chloride-containing liquid waste and then mixed with the solution of the water-soluble amine, obtaining the calcium carbonate product in step (1) as calcium carbonate in the form of calcite;
when a molar ratio of the calcium chloride to the water-soluble amine is not greater than 1:2, when the materials are added so that the calcium chloride solution is added to a solution of the water-soluble amine, and when the CO₂ is added in such a manner that it is introduced into the solution of the water-soluble amine and then mixed with calcium chloride-containing liquid waste, or that it is introduced into calcium chloride-containing liquid waste and then mixed with the solution of the water-soluble amine, obtaining the calcium carbonate product as calcium carbonate in the form of vaterite by running the mineralization reaction at a low temperature of 10-40° C., preferably 20-30° C., or obtaining the calcium carbonate product as calcium carbonate in the form of calcite by running the mineralization reaction at a high temperature of 50-80° C., preferably 60-70° C.

14. The method according to claim 1, characterized in that when the calcium chloride solution is mixed with a solution of the water-soluble amine by direct pouring, the calcium carbonate product is obtained in step (1) as calcium carbonate with a small particle size, which is calcium carbonate with an average particle size of smaller than 20 μm, preferably calcium carbonate with an average particle size of smaller than 10 μm, or
when the calcium chloride solution is mixed with a solution of the water-soluble amine by dropwise addition, the calcium carbonate product is obtained in step (1) as calcium carbonate with a large particle size, which is calcium carbonate with an average particle size of greater than 10 μm, preferably calcium carbonate with an average particle size of greater than 20 μm.
